(19) United States
(12) Patent Application Publication
(10) Pub. No.: US 2008/0036740 A1
(43) Pub. Date: Feb. 14, 2008

(54) ELECTRONIC PEN/MOUSE SYSTEM

(76) Inventor: Felipe Bracho, Del Valle (MX)

Correspondence Address: GOTTLIEB RACKMAN & REISMAN PC, 270 MADISON AVENUE, 8TH FLOOR, NEW YORK, NY, 10016-0601, US

(21) Appl. No.: 11/744,968

(22) Filed: May 7, 2007

Related U.S. Application Data
(60) Provisional application No. 60/798,274, filed on May 5, 2006.

(51) Int. Cl. G09G 5/08

(52) U.S. Cl. 345/163

(57) ABSTRACT

An interactive display system in which a computer controls display of source content on a display device is provided. An electronic mouse causes the computer to add to the display additional indicia representing movement of the mouse, the mouse providing the computer with data on both its movement and when the movement should be represented by additional indicia on the display. The computer and mouse cooperate to calibrate the system so that movement of the mouse properly scales the additional indicia that are displayed. The computer also controls display of a cursor to represent the position of the mouse on the surface to which it is moved.

### BACKGROUND OF THE INVENTION

Historically, content has been presented to a large audience (for example, in a class room, lecture balk etc.) using the traditional blackboard and chalk, or by projecting still and/or moving/images an a white screen. Overhead projectors used with transparent sheets were also very popular. A problem with all these devices was that the presentations were fairly passive and it was difficult to retain the attention of the audience.

With the advent of various electronic devices, more interactive and entertaining systems were developed. One such device is the electronic projector that receives electronic signals and generates from these signals images that are projected on a passive screen. The projector is coupled to a laptop or other similar device and the presenter controls what is being displayed from the laptop. A disadvantage of this system is that the presenter is tied to his laptop and cannot actively alter or manipulate the images on the screen, except by merely pointing at the images.

Another new system used to display content is the electronic white board. The electronic white board is a combination of a standard white screen and an electronic tablet. A presenter can write on the whiteboard a no the taxi and graphics thus generated are electronically captured, stored and displayed on any number of screens. Typically, a whiteboard includes a flat white writing surface on which a presenter or others can write using standard markers and sensors imbedded in either the whiteboard itself or peripherally about the hoard. The sensors are connected to a PC or similar device for processing and generating the appropriate images.

In an interesting twist, some whim boards work with electronic ink, e.g., the presenter uses a rod which may look like a pen but, in actuality, does not make any real marks. Instead, writing is performed with “electronic ink” to generate text or graphics that are projected onto the whiteboard. Thus, the presenter does not actually write on the board, but merely simulates writing and the text or graphics generated by the presenter are thereby presented to every one as electronic images.

Electronic whiteboards can act as screens and receive images from projector as well. A problem with electronic whiteboards is that they ere extremely expensive and, accordingly, they are not used, or used sparingly in places they are needed the most: poor areas where residents may not have sufficient income to take advantage of these systems.

### SUMMARY OF THE INVENTION

The invention is an interactive display system in which a computer controls display of source content on a display device. An electronic mouse causes the computer to add to the display additional indicia representing movement of the mouse, the mouse providing the computer with data on both its movement and when the movement should be represented by additional indicia on the display. The computer and mouse cooperate to calibrate the system so that movement of the mouse properly scales the additional indicia that are displayed. The computer also controls display of a cursor to represent the position of the mouse on the surface on which it is moved. Sensors in the mouse determine the direction and speed of ovation of the mouse. A manually operated button on the mouse can inform the computer when the mouse movement should be represented by additional indicia on the display.

It is therefore an object of the invention to provide an interactive display system in which a computer controls the display of source content and an electronic mouse communicates with the computer to cause it to control the display of additional indicia representing movement of the mouse.

It is another object of the invention to enable the computer to determine when the mouse movement should be represented by additional indicia on the display.

It is a further object of the invention to allow calibration of the system so that movement of the mouse properly scales the additional indicia that are displayed.

It is yet another object of the invention to control the display of a cursor representing the position of the mouse.

Still another object of the invention is to allow a user to manually determine when the mouse movement should be represented by additional indicia on the display.

Still other objects and advantages of the inventions will, in part, be obvious and will, in part, be apparent from the following description.

### BRIEF DESCRIPTION OF THE DRAWINGS

FIGS. 1A, 1B and 1C show a top, side and front views of an electronic pen/mouse constructed in accordance with this invention;

FIG. 2 shows a block diagram for the electronic pen/mouse of FIGS. 1A, 1B; and

FIG. 3 snows an isometric view of a presenter using the device on a large standard board.

### DETAILED DESCRIPTION

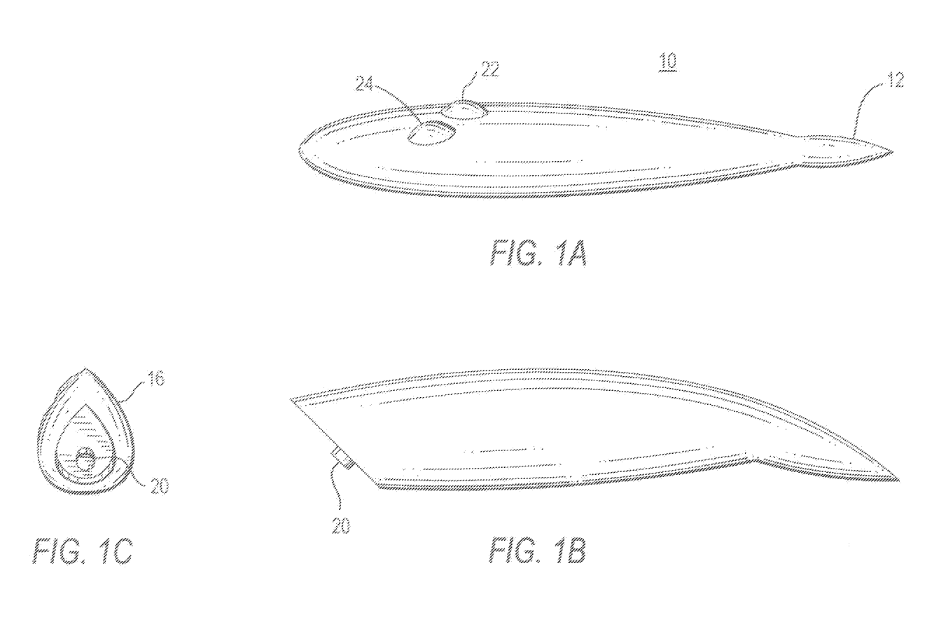

FIGS. 1A, 1B and 1C show a pointing device generally indicated at 10 that resembles, in structure, an electronic pen or electronic mouse. Pointing device 10 includes an economically shaped housing 12. At a front end, the pointing device 10 has an optical tracking mechanism 16. Tracking mechanism 16 is used to track the movement of device 10 across any surface. Tracking mechanism 16 may be an IR mechanism similar to the ones used in standard mouse devices, or may be implemented using other types of sensors.

Preferably, adjacent to tracking mechanism 16 there is an activating or contact sensor 20. Sensor 20 could be a mechanical switch, a proximity sensor or other similar sensor. Sensor 20 is used to detect when device 10 has been placed in contact with a surface and is ready to be used. Contact sensor 20 may be placed at other locations as well, or can be a momentary switch activated manually by the user.

On top of the housing there are two buttons or switches: left switch 22 and eight switch 24. These buttons perform the same functions as the left and right buttons on any standard mouse.

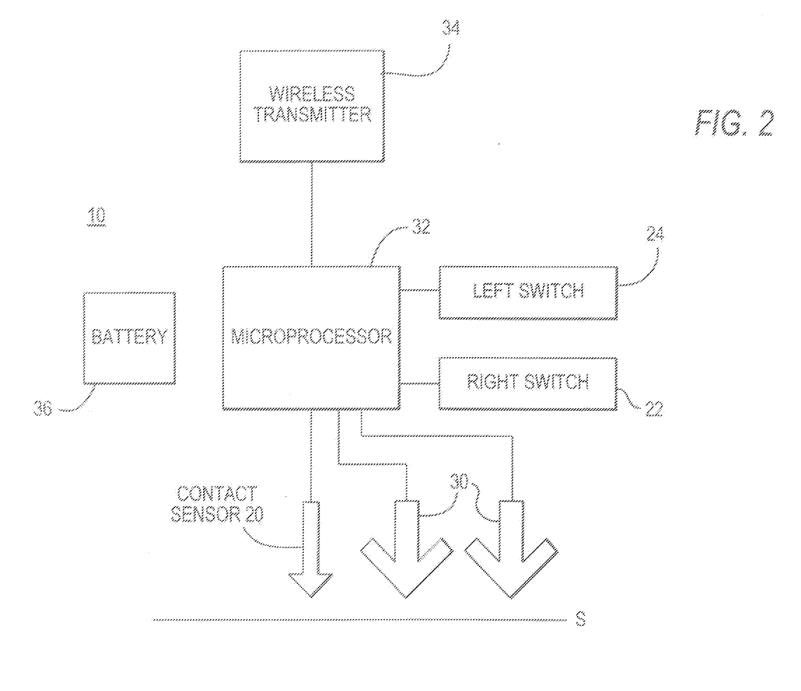

Referring now to FIG. 2, device 10 includes two or more motion/position sensors 30 disposed adjacent to the contact sensor 20. The sensors 30 are used to determine the direction and speed of motion of device 10 with respect to a reference surface S. The sensors may include a trackball and/or a light source that is directed at the surface S or the trackball, and the reflected light is used to determine the relative motion between the device 10 and the surface S. Other means of determining this motion may be used as well. The information from sensors 20, 30 and switches 22, 24 is provided to a microprocessor 32. Microprocessor 32 determines the motion of the device and sends it to a wireless transmitter 34. Transmitter 34 then transmits this information to a remote location. Power to the mouse is provided by a battery 36.

Device 10 shown in FIGS. 1A-C and 2 can be used as a standard mouse for normal, every day operation of a PC laptop and so forth. Moreover, because it is more manageable than a standard mouse, it can be used for more detailed work. Per example, the device can be used to “write” text and “sign” documents.

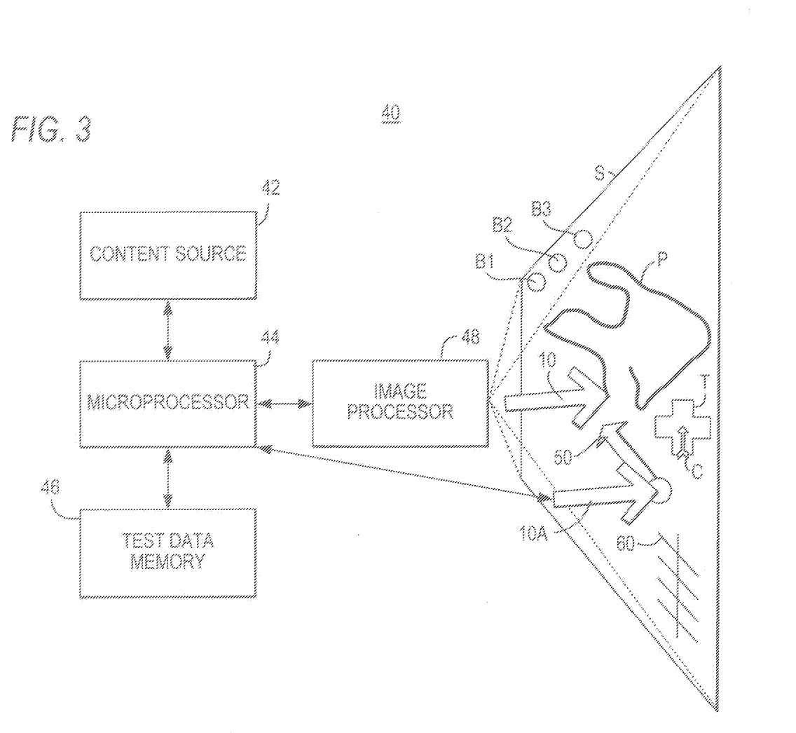

Importantly, device 10 may also be used for making presentations to audiences as follows. Referring to FIG. 3, a presentation system 40 is shown including soma content source 42, a microprocessor 44, a test data memory 46 and an image projector 48. Normally, presentation device 40 (which may be a modified electronic projector, or other similar devices) receives information from content source 42 and sends it to image projector 48. Corresponding images are then formed on screen S.

It should be appreciated that while the screen may well be an electronic whiteboard, as discussed above, for the purposes of this invention, it can also be a passive white sheet, a screen or other surface. As will be discussed below, it may even be the surface of a desktop or laptop computer monitor. The pointing device can be used in a number of different ways. For example, a user may augment whatever is being displayed by adding lines, test, graphics etc. to the original image. In order to accomplish this, the user places pointing device 10 on the screen. Microprocessor 44 knows that device 10 is on screen S because the user activates sensor 20, or sensor 20 is activated automatically on contact with (or proximity to) the screen. The user then moves pointing device 10 amend screen S. The microprocessor 44 monitors the movement of pointing device 10 and interprets it in the same manner as it would interpret the movement of a standard mouse. For example, if the use draws a curve P, microprocessor 44 generates curve P and superimposes it on the image as shown. Alternatively, as part of the image, some buttons B1, B2, B3, B4 may be projected on the screen. The user can move the pointing device to one of the buttons and click on either left switch 22 or rigid switch 24. Microprocessor 44 then takes an appropriate action in response. The user can perform all other functions normally associated with a standard mouse in the same manner.

Before he can start the echoes the user may have to provide some initial information to the microprocessor about his starting point. For example, he may start by placing pointing device 10 so that it points at target T. Microprocessor 44 then generates a standard cursor C at target T. All future movements of pointing device 10 are then indicated by the position of cursor C.

Presentation system 40 may need to be calibrated at certain times so that the movement of the pointing device 10 is tracked accurately with cursor C. It is expected that calibration is mostly necessary whenever a different screen is used, or the distance from projector 48 to screen S is changed. For this purpose, microprocessor 44 first generates a test or calibration image 50. Image 50 may be stored in memory 46 and can take many forms. In FIG. 3, test image 50 consists of a circle and an arrow. For calibration, the riser places pointing device 10 in position 10A so that it touches image 50 at the circle. The user then activates one of switches 22,24, draws pointing device 10 along image 50 until the tip of the arrow and then releases switch 22. From this movement of device 10, microprocessor 44 determines the parameters necessary to scale the movement of device 10 properly so that it can be correctly superimposed on the screen S. Since this movement is precisely mimicked by the position of the cursor C, the user can easily determine if the calibration is correct, or if the system requires recalibration.

Many other ways can be provided for performing the calibration. For example, instead of projecting the test image 50, a test image 60 can be drawn or printed on the screen itself. Test image 60 may consist of a plurality of horizontal lines and a vertical line. System 40 is then calibrated by passing the pointing device 10 along the vertical line. The distance between the horizontal lines is then known to the microprocessor 44, and as the device 10 passes over these lines, the microprocessor 44 can determine the proper sealing factors.

1. An interactive display system comprising a display device, a computer for controlling the display of source content on said display device, and an electronic mouse for communicating with said computer to cause said computer to control the display on said display device of additional indicia representing movement of said mouse, said mouse including means for enabling said computer to determine movement of said mouse and means for enabling said computer to determine when the mouse movement should be represented by additional indicia on said display device.

2. An interactive display system in accordance with claim 1, wherein said computer and said mouse cooperate to calibrate the system so that movement of said mouse properly scales the additional indicia that are displayed.

3. An interactive display system in accordance with claim 2, wherein said computer controls the display on said display device of a cursor representing the position of said mouse.

4. An interactive display system in accordance with claim 3, wherein said means for enabling said computer to determine movement of said mouse includes sensors for determining the direction and speed of motion of said mouse on a reference surface.

5. An interactive display system in accordance with claim 4, wherein said means for enabling said computer to determine when the mouse movement should be represented by additional indicia on said display device is manually operated.

6. An interactive display system in accordance with claim 1, wherein said computer controls the display on said display device of a cursor representing the position of said mouse.

7. An interactive display system in accordance with claim 6, wherein said means for enabling said computer to determine movement of said mouse includes sensors for determining the direction and speed of motion of said mouse on a reference surface.

8. An interactive display system in accordance with claim 7, wherein said means for enabling said computer to determine when the mouse movement should be represented by additional indicia on said display device is manually operated.

9. An interactive display system in accordance with claim 1, wherein said means for enabling said computer to determine movement of said mouse includes sensors for determining the direction and speed of motion of said mouse on a reference surface.

10. An interactive display system in accordance with claim 9 wherein said means for enabling said computer to determine when the mouse movement should be represented by additional indicia on said display device is manually operated.

11. An interactive display system in accordance with claim 1 wherein said means for enabling said computer to determine when the mouse movement should be represented by additional indicia on said display device is manually operated.
